(19) United States
(12) Patent Application Publication
(10) Pub. No.: US 2023/0195447 A1
(43) Pub. Date: Jun. 22, 2023

(54) Method for expanding application possibilities of a sensor, sensor and application of the sensor

(71) Applicant: Endress+Hauser Conducta GmbH+Co. KG, Gerlingen, DE (US)

(72) Inventors: Stefan Kempf, Kornwestheim (DE); Stefan Robl, Hünxe (DE)

(21) Appl. No.: 18/067,056

(22) Filed: Dec. 16, 2022

(30) Foreign Application Priority Data
Dec. 16, 2021 (DE) 10 2021 133 560.4

(51) Int. Cl. G06F 8/65; G06F 9/54

(52) U.S. Cl. CPC G06F 8/65; G06F 9/541

(57) ABSTRACT

The present disclosure discloses a method for expanding application possibilities of a sensor, comprising the steps of transmitting an app to the sensor via a communication interface of the sensor when the app is not yet on the sensor, wherein the firmware of the sensor is configured to receive and store apps; wherein the app comprises at least identification features, such as the name and version, one or more entry points, and a main logic; selecting the app via a communication interface of the sensor by means of a higher-level unit via the identification features of the app; executing the selected app, wherein the sensor calls the entry point; and returning at least one return value from the app to the sensor.

### CROSS-REFERENCE TO RELATED APPLICATION

The present application is related to and claims the priority benefit of German Patent Application No. 10 2021 133 560.4, filed on Dec. 16, 2021, the entire contents of which are incorporated herein by reference.

### TECHNICAL FIELD

The present disclosure relates to a method for expanding application possibilities of a sensor, a sensor, and an application of the sensor.

### BACKGROUND

Sensors, primarily optical sensors, detect physical parameters (raw values, frequently as a voltage value) and calculate from them measured values that are relevant for the application. One example is the calculation of the fat content in milk on the basis of the light spectrum of the milk. Another example is the determination of the concentration of a specific substance on the basis of the conductivity of the measurement medium. The algorithms responsible for converting raw values into measured values are referred to as (computing) models.

The models in the sensors cannot be supplemented as desired or even exchanged. The sensor comprises either only one set of models (or only a single model) that is permanently installed in the firmware, wherein the set is parameterizable at most minimally, if at all.

Sensors often support more applications than originally assumed on account of their technical data. For example, a turbidity sensor which was actually developed for the measurement of slurries in the wastewater field would also be able, on account of the measurement principle, to measure fat content in milk. However, because the model for determining the fat content can only enable the sensor to measure it via a complex firmware update, the sensor remains in the original application.

### SUMMARY

The object of the present disclosure is to expand the functional scope of a sensor in a simple manner.

The object is achieved by a method comprising the steps of transmitting an app to the sensor via a communication interface of the sensor when the app is not yet on the sensor, wherein the firmware of the sensor is configured to receive and store apps; wherein the app comprises at least identification features, such as the name and version, one or more entry points, and a main logic; selecting the app via a communication interface of the sensor by means of a higher-level unit via the identification features of the app; executing the selected app, wherein the sensor calls the entry point; and returning at least one return value from the app to the sensor.

One embodiment provides that, during the execution of the app, the sensor provides one or more parameters to the entry point.

One embodiment provides that the sensor comprises an application programming interface (API) and through it, the app queries one or more parameters from the sensor.

One embodiment provides that the sensor cyclically calls the entry point.

One embodiment provides that the step “returning at least one return value from the app to the sensor” is carried out as a direct return of the app to the sensor.

One embodiment provides that the step “returning at least one return value from the app to the sensor” is carried out by the sensor comprising an application programming interface (API) via which the app communicates the return value to the sensor.

One embodiment provides that the app is an app for calculating a measured value via a model, wherein the sensor of the app transmits the raw value as a parameter, or the app calls the raw value via the application programming interface (API), wherein the main logic comprises algorithms for signal processing and routines for calculating the measured value from a raw value via the model, and wherein the measured value is the return value.

One embodiment provides that the sensor comprises a plurality of apps.

This comprises the two cases that: different apps, such as different models, are used for the same measurement parameter, and also, however, different apps, such as different models, are also used for different measurement parameters.

In the first case, there is a different measurement performance, for example with respect to accuracy, for example separately in measurement regions or the like. In the second case, for example, a determined spectrum is processed differently for a different parameter.

One embodiment provides that the sensor comprises a plurality of apps, and each app comprises a different model for calculating a measured value.

One embodiment provides that the measured values from the different apps are compared, and a measured value is selected in the event of a deviation. The various apps can continue to run. The “correct” measured value is selected on the basis of a defined criterion, for example that the measured value is greater than or less than a certain threshold value.

One embodiment provides that the measured values from the different apps are compared, and an alarm is triggered in the event of a deviation above a threshold value.

One embodiment provides that the model is configured for a single measurement point.

One embodiment provides that the app is configured or status queries are carried out via the entry point of the sensor.

One embodiment provides that the sensor comprises a virtual machine. In one embodiment, the virtual machine is configured as an interpreter, such as an emulator, as an ahead-of-time compiler, just-in-time compiler, hypervisor, or a combination thereof.

One embodiment provides that the sensor comprises an interpreter, such as a software emulator or a script language interpreter, the app is present in an interpretable format on the sensor, and the app is executed via the interpreter.

One embodiment provides that the sensor comprises a just-in-time compiler, and the app is present on the sensor in a corresponding format.

One embodiment provides that the sensor comprises an ahead-of-time compiler, and the app is present on the sensor in a corresponding format.

One embodiment provides that a plurality of interpreters/compilers can be executed per sensor, such as only one app is executed per interpreter/compiler.

One embodiment provides that the sensor provides one or more system calls for the app, wherein the app comprises system call stubs.

One embodiment provides that a system call comprises optimized signal processing routines and sensor functions in order to query the current raw values and determine the calculated measured value.

The object is further achieved by a sensor for carrying out the method described above, comprising a sensor element for detecting a measured variable of a measurement medium and a data processing unit having a memory.

One embodiment provides that the sensor is designed as an optical sensor with a light source and a light receiver; for example, the sensor is a spectrometer.

One embodiment provides that the sensor, in order to detect boundary layers or the fill level, is configured as a sludge blanket sensor with a transmitter for transmitting electromagnetic waves, light, for example optical light, acoustic waves, or ultrasound in the direction of the boundary layer or the surface, and with a receiver for receiving the returned waves or light.

One embodiment provides that the sensor is designed as a two-dimensional optical sensor, such as for particle or bacterial counts.

One embodiment provides that the sensor is designed as a three-dimensional optical sensor, such as a lidar sensor.

The object is further achieved by the application of the method as described above with a sensor as described above for determining the composition, for example the fat content, of milk.

### BRIEF DESCRIPTION OF THE DRAWINGS

This is explained in more detail with reference to the following figures.

FIG. 1 shows the core of the claimed method in an overview.

FIG. 2 shows the claimed sensor.

FIG. 3a/b show the app.

In the figures, the same features are labeled with the same reference signs.

### DETAILED DESCRIPTION

Because of their measuring principle, sensors often support many more applications than originally assumed. For example, a turbidity sensor which was actually developed for the measurement of slurries in the wastewater field would also be able, because of the measurement principle, to measure fat content in milk. In order to be able to provide flexible new applications in this case, models should not be permanently stored in the sensor, but instead be developed in the form of reloadable apps.

Thus, also sensors which have already been produced are able, without a firmware update, to operate new applications. Likewise, customers who want to use their sensor for a different application can easily modify them. The ability to reload the computing models makes it possible to use highly specialized computing models which are optimized, where appropriate, only to a single measurement point.

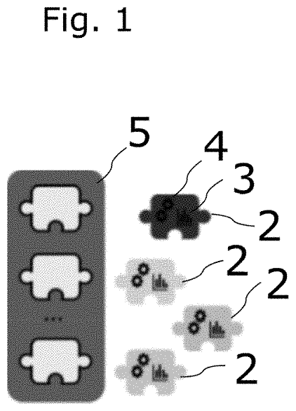

FIG. 1 shows the sensor 1 with reloadable apps 2 with completely freely definable signal processing 3, i.e., models, and parameterization 4. The sensor 1 comprises a data processing unit 14 with a memory 5 that is large enough to store a plurality of apps 2 (symbolized by the open regions).

The app 2 is therefore a (down)loadable piece of program code which offers additional functions to the host, that is to say, the sensor 1. The loadable code is structured to interact with the sensor 1 at two ends: there are entry points 22, generally interface methods, which call the sensor to retrieve a certain functionality in the app 2; example: Calculation of measured values, see below, and the sensor 1 provides functions via system calls 24a, which are called via system call stubs 24 within the app; example: Access to index structures or expanded computing methods

The execution of the app 2 is denied if the system calls 24a or interface methods 22 are not present, or are present only in an incompatible version, or do not match the target system, i.e., the app 2 has been written for an incorrect base system 1. The app 2 is aborted if it attempts, at runtime, to execute a system call 24a that is not present in the base system 1 or is present in an incompatible version.

The firmware of the sensor 1 is designed in such a way that it can receive the apps 2 via an interface and store them internally. The sensor 1 offers a communication interface 6, by means of which the sensor 1 is informed which of the stored apps is to be loaded for the measured value calculation. The sensor 1 is connected via the communication interface 6 to a higher-level unit, for example a transmitter (measuring transducer) or a control system (control room). The communication interface 6 is usually wired and may be subject to a proprietary protocol or to a bus system such as HART, Modbus, Foundation Fieldbus, or others.

The sensor 1 will be discussed in more detail below.

The sensor 1 comprises at least one light source 11, a spectrometer 13 and a data processing unit 14. The sensor 1 or the data processing unit 14 is designed to carry out the steps of the claimed method, that is to say, for example, to switch the light source 11 on and off or to execute the data processing.

An optical sensor, more precisely a spectrometer, is shown. This is explained in more detail below. In principle, however, the claimed method can also be applied to other sensors with other physical or chemical measuring methods.

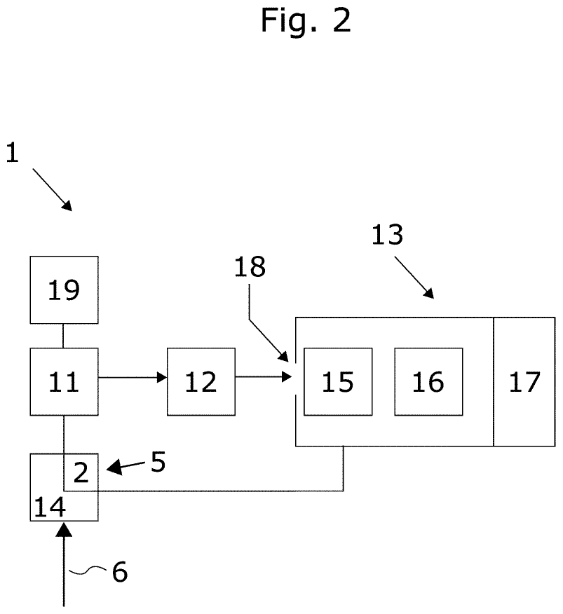

The spectrometer 13 is only shown symbolically in FIG. 2 and comprises, for example, at least one beam-shaping element, for example a mirror 15, a grating 16 (in general, a dispersive element, for example also a prism) and a receiver 17. Mirror 15 and grating 16 can be configured as a single component. The receiver is configured as a CCD sensor or linear array detector. At the entrance of the spectrometer 13 is an entrance slit 18. In principle, the idea according to the present disclosure works for all spectrometric measuring systems, irrespective of whether a prism or grating is used, for instance.

Light from the light source 11, which is configured, for example, as a xenon flash lamp, is transmitted from the light source 11 in the direction of the measurement medium 12. The light source 11 can also be designed as an LED. If the emission spectrum of the light source 11 is temperature-dependent, the sensor 1 comprises a temperature sensor 19 which is arranged at, in, or at least in the vicinity of the light source 1. The emission spectrum can thereby be corrected with respect to the temperature if necessary.

A transmission measurement is shown. For this purpose, the light source 11 comprises one or more windows which are at least partially transparent to the emitted light. The measurement medium 12 is separated from the optical and electronic components of the sensor 1 by the windows. Other measuring principles such as absorption measurement, scattering or fluorescence measurement are also possible.

The data processing unit 14 comprises one or more apps 2, represented by the square box. The apps 2 are located in the memory 5. If the apps 2 are not yet in the memory 5, the app 2 is loaded thereon. This is done, for example, via the communication interface 6. Depending on the configuration of the sensor, the apps 2 can also be directly transmitted to the sensor, for example via a wireless data connection such as Bluetooth or the like. Likewise, the apps 2 can be loaded via a memory card, for example an SD card, into the data processing unit 14 if the sensor 1 comprises such a possibility.

In order to distinguish the apps 2 stored in the sensor 1, the apps 2 must carry an identification feature 21, such as the name and version of the app, for example as meta-information. The app 2 is present, for example, as an image file in which the actual program code and the identification feature 21 (meta-information) of the app 2 itself are located.

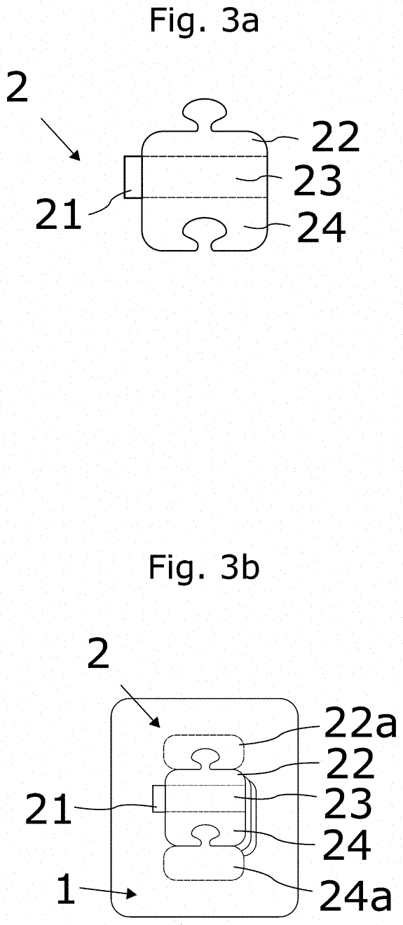

This also shows the general representation of the app 2 in FIG. 3a. The app 2 comprises, for example, three parts: the actual main logic 23, interface methods 22 which are called by the basic system, and system call stubs 24, on the basis of which functionality is called in the sensor 1.

The code of the app 2 can consist of any algorithms in order to convert the raw values into measured values. Raw values are the physical parameters such as a voltage value, while the measured value represents for example the fat content of milk or a concentration of a specific substance in the medium to be measured. In order to be more specific: in the example set out above, the interface methods 22 are the entry points for the measured value calculation. The main logic 23 represents the actual algorithms for signal processing. System calls 24 would be, for example, optimized routines which are frequently used in signal processing algorithms and sensor functions in order to query the current raw values and determine the calculated measured value. The sensor 1 can give the interface method 22 of the app 2 the current raw values as parameters, or the app 2 can query the current raw values of the sensor 1 via an API. The app 2 supplies the measured values, if applicable with the respective unit, back to the sensor 1a, for example as a return value, or by the sensor providing an API via which the app communicates the current measured value and the unit.

FIG. 3b shows the relationship between the app 2 and the sensor 1. A plurality of apps 2 can run simultaneously on the sensor 1. This is illustrated by the puzzle parts shown lying among each other in the middle of the drawing. In the sensor 1, there are interface stubs 22a, on the basis of which the interface methods 22 in the app 2 are called. The sensor 1 offers the app 2 functionalities in the form of system calls 24a. In order for an app 2 to be able to call up the system calls 24a in the sensor 1, there are corresponding system call stubs 24 in the app 2.

As shown in FIG. 3b, a plurality of apps 2 can be executed simultaneously, but all apps 2 have the same interfaces for the same sensor type. In one embodiment, apps 2 run in an isolated environment in order to prevent a defective app 2 from causing the host (sensor 1) to crash. Because of this isolation, the sensor cannot directly call a method in the app 2. The app 2 also cannot perform direct calls to the sensor 1. Apps 2 also run in their own address space, and by default cannot access data of the sensor 1.

Instead, the process runs as shown. In order to interact with an app 2, there are interface stubs 22a on the sensor side. An app 2 is “entered and exited” only via the interface stubs 22a. If the sensor 1 calls a stub 22a, a dispatch mechanism enters the app 2 and calls the corresponding interface method 22. The interface methods 22 call the main logic 23 which executes and returns their function. The main logic 23 can additionally access system calls 24a. In this case, the main logic 23 calls a stub 24, and a dispatch mechanism forwards a system call 24a on the sensor side. Now the execution is again in the sensor 1, the system call 24a executes its action, then returns to the app 2, and finally the app 2 returns to the sensor 1. The application code can consist of a main loop, so that this cycle can be infinitely repeated.

The sensor 1 must be able to load and execute apps 2, for example by the sensor firmware implementing a virtual machine in which apps are interpreted/executed. The virtual machine is configured as an interpreter, such as an emulator, as an ahead-of-time compiler, just-in-time compiler, hypervisor, or a combination thereof. The CPU architecture of host (sensor 1) and guest (app 2 running thereon) do not have to be exactly the same. In the case of hypervisors, however, it is advisable for a performing embodiment of the app to select the same CPU command set.

In the embodiment as a virtual machine, inherent measures for memory protection, and thus also security, are obtained. A possible malicious code cannot reach beyond the virtual machine and, as a result, cannot negatively affect the firmware or other virtual machines that are running (a plurality can run in parallel, see below). There is a separation between the different virtual machines, because no common memory regions are used. The different virtual machines interact only via defined interfaces, so that only limited functions can be executed thereby. The virtual machine, in its embodiment as an interpreter (emulator), forms an environment for executing the app in the form of a virtual CPU with a virtual working memory. This system is, in this case, isolated from the rest of the system, i.e., from the host system, i.e., from the firmware of the sensor. If an app is defective, it does not affect the rest of the system. The rest of the system continues to run, even if the defective extension crashes. Communication is carried out via defined interfaces.

However, the app 2 can also be executed “natively” on the sensor. For this purpose, the sensor 1 comprises, for example, an ahead-of-time compiler or a just-in-time compiler. The app 2 is present in a corresponding format on the sensor 1.

If emulation is not carried out via a virtual machine (see above) and the CPU architectures of host and guest match, support of the processor of the sensor 1 is necessary to execute the app, e.g., a memory management unit (MMU) is needed in hardware so that the memory protection can be realized.

For interpretation/execution of apps, the program code must be contained that can be interpreted/executed or translated into an interpretable/executable form, for example machine-independent bytecode. Likewise, the program must be stored in a binary format, for example in the executable and linking format (ELF). The binary format provides information about the memory layout of the app, e.g., position and size of code and data. This information is necessary for loading an app and for preparing its execution.

The program code can be executed via an interpreter (virtual machine) or can be translated before execution into the machine code of the processor used on the sensor (compiler).

The entry points can be, for example, program addresses stored in the meta-information, for example as part of the identification feature 21. The virtual machine or the compiler then executes the app 2 starting from this program address.

The entry points can also be IDs as identification. The virtual machine always calls the app 2 on a start address stored in the ELF file with the entry point ID as a further argument. The app 2 must be programmed such that it evaluates the ID and calls the desired entry point. The ID can be explicitly entered during creation of the app or is assigned automatically.

The apps 2 provide an entry point (see above, “interface methods 22”) that the sensor 1 calls in order for the app 2 to calculate a measured value from the currently detected raw values. The sensor 1 can assign the current raw values as parameters to the entry point of the app 2, or the app 2 can query the current raw values from the sensor via an API.

The sensor 1 provides generic, optimized signal processing routines that the app can access.

The app 2 returns the measured values, if applicable with the respective unit, to the sensor 1, for example as a return value, or by the sensor providing an API through which the app communicates the current measured value and the unit.

The apps 2 can also have further entry points through which the sensor, for example, configures the app, makes status queries, etc.

In a further embodiment, the sensor 1 can operate two or more different models for one and the same application. The different models can thus be compared to one another in order, for example, to decide through the user or the machine which model calculates the more accurate measured values, or to detect deviations between the calculated measured values and to warn that an unusual situation has occurred in the process. The comparison is carried out, for example, via a threshold value, i.e., in the event of a deviation above the threshold value, a different model is selected (i.e., a different app 2), or even an alarm is triggered. In a further embodiment, the sensor 1 can operate one, two or more different models for two or more different applications. As a result, for example in the case of a spectrometer, the concentrations of different substances in the measurement medium can be determined on the basis of the same raw measured values.

1. A method for expanding application possibilities of a sensor, comprising the steps of:
transmitting an app to the sensor via a communication interface of the sensor when the app is not yet located on the sensor,
wherein the firmware of the sensor is configured to receive and store apps;
wherein the app comprises at least identification features, including the name and version, one or more entry points, and a main logic;
selecting the app via a communication interface of the sensor using a higher level unit via the identification features of the app;
executing the selected app, wherein the sensor calls the entry point; and
returning at least one return value from the app to the sensor.

2. The method according to claim 1,
wherein during the execution of the app, the sensor provides one or more parameters to the entry point.

3. The method according to claim 1,
wherein the sensor comprises an application programming interface (API), and the app queries one or more parameters of the sensor.

4. The method according to claim 1,
wherein the sensor cyclically calls the entry point.

5. The method according to claim 1,
wherein the step “returning at least one return value from the app to the sensor” is carried out as a direct return of the app to the sensor.

6. The method according to claim 1,
wherein the step “returning at least one return value from the app to the sensor” is carried out by the sensor comprising an application programming interface via which the app communicates the return value to the sensor.

7. The method according to claim 1,
wherein the app is an app for calculating a measured value via a model,
wherein the sensor of the app transfers the raw value as a parameter, or the app calls the raw value via the application programming interface,
wherein the main logic comprises algorithms for signal processing and routines for calculating the measured value from a raw value via the model, and
wherein the measured value is the return value.

8. The method according to claim 1,
wherein the sensor comprises a plurality of apps.

9. The method according to claim 1,
wherein the sensor comprises a plurality of apps, and each app comprises a different model for calculating a measured value.

10. The method according to the 9,
wherein the measured values from the different apps are compared, and a measured value is selected in the event of a deviation.

11. The method according to claim 9,
wherein the measured values from the different apps are compared, and an alarm is triggered in the event of a deviation above a threshold value.

12. The method according to claim 7,
wherein the model is configured for a single measurement point.

13. The method according to claim 1,
wherein via the entry point, the sensor configures the app, or status queries are run.

14. The method according to claim 1,
wherein the sensor comprises an interpreter, the app is present on the sensor in an interpretable format, and the app is executed via the interpreter.

15. The method according to claim 1,
wherein the sensor comprises a just-in-time compiler, and the app is present in a corresponding format on the sensor.

16. The method according to claim 1,
wherein the sensor comprises an ahead-of-time compiler, and the app is present in a corresponding format on the sensor.

17. The method according to claim 1,
wherein a plurality of interpreters/compilers can be executed per sensor.

18. The method according to claim 1,
wherein the sensor provides one or more system calls for the app, wherein the app comprises system call stubs.

19. The method according to claim 1,
wherein a system call comprises optimized signal processing routines and sensor functions to query the current raw values and determine the calculated measured value.

20. A sensor for executing the method according to claim 1, comprising:
a sensor element for detecting a measured variable of a measurement medium;
a data processing unit with a memory.

21. The sensor according to claim 20,
wherein the sensor is designed as an optical sensor with a light source and a light receiver.

22. A use of the method according to claim 1, with a sensor according to any one of the preceding claims for determining the composition of milk.
